(19) United States
(12) Patent Application Publication
(10) Pub. No.: US 2008/0180355 A1
(43) Pub. Date: Jul. 31, 2008

(54) ARRAY SUBSTRATE AND DISPLAY APPARATUS HAVING THE SAME

(76) Inventors: So-Young LEE, Yongin-si (KR); Il-Gon KIM, Seoul (KR); Young-Joo CHANG, Suwon-si (KR)

Correspondence Address: F. CHAU & ASSOCIATES, LLC, 130 WOODBURY ROAD, WOODBURY, NY, 11797, US

(21) Appl. No.: 11/964,455

(22) Filed: Dec. 26, 2007

(30) Foreign Application Priority Data
Jan. 30, 2007 (KR) 10-2007-009496

(51) Int. Cl. G09G 3/20

(52) U.S. Cl. 345/55

(57) ABSTRACT

An array substrate comprises a gate line formed on a substrate, a plurality of data lines insulated from the gate line, a pixel area including a first sub-area and a second sub-area, a thin film transistor formed in the pixel area, a pixel electrode formed on the thin film transistor, the pixel electrode electrically connected to the thin film transistor, a storage line formed on the substrate, the storage line spaced apart from the gate line and positioned at a first boundary of each of the pixel areas and a floating electrode formed on the substrate, the floating electrode spaced apart from the gate line and the storage line, and positioned at a second boundary of the pixel area.

### CROSS-REFERENCE TO RELATED APPLICATION

This application claims priority to Korean Patent Application No. 2007-09496 filed on Jan. 30, 2007, the contents of which are herein incorporated by reference in its entirety.

### BACKGROUND OF THE INVENTION

1. Technical Field

The present invention relates to an array substrate and a display apparatus having the array substrate, and more particularly, to an array substrate capable of improving an aperture ratio.

2. Discussion of the Related Art

A display apparatus includes a plurality of pixels to display an image. A liquid crystal display apparatus includes an array substrate on which pixel areas corresponding to the pixels are formed and an opposite substrate coupled with the array substrate.

The pixel areas can be defined by signal lines arranged on the array substrate. The opposite substrate is provided with a light blocking member arranged thereon to block light passing through between the pixels. In order to increase an area through which the light passes in each pixel, a size of the light blocking member can be reduced. However, since a misalignment occurs between the array substrate and the opposite substrate when the array substrate is coupled with the opposite substrate, the light blocking member may have a size enough to prevent a light leakage.

Thus, technologies are required to enhance an aperture ratio of the pixels and prevent the misalignment between the array substrate and the opposite substrate.

### SUMMARY OF THE INVENTION

Embodiments of the present invention provide an array substrate capable of enhancing an aperture ratio and preventing a misalignment thereof, and a display apparatus having the array substrate.

In an exemplary embodiment of the present invention, an array substrate includes a gate line, data lines, a thin film transistor, a pixel electrode, a storage line and floating electrodes.

The gate line is arranged on a substrate. The data lines are insulated from and intersected with the gate line. A plurality of pixel areas include a first sub-area and a second sub-area with respect to the gate line. The thin film transistor is formed in each of the pixel areas. The pixel electrode is formed on the thin film transistor and electrically connected to the thin film transistor. The storage line is formed on the substrate and positioned at a first boundary of each of the pixel areas while being spaced apart from the gate line. The floating electrodes are formed on the substrate and positioned at a second boundary of each of the pixel areas while being spaced apart from the gate line and the storage line.

In an exemplary embodiment of the present invention, a display apparatus includes a first substrate, a plurality of pixel areas, a thin film transistor, a pixel electrode, a storage line, floating electrodes and a second substrate.

The first substrate includes a gate line and a plurality of data lines insulated from and intersected with the gate line. The pixel areas include a first sub-area and a second sub-area with respect to the gate line. The thin film transistor is formed in each of the pixel areas. The pixel electrode is formed on the thin film transistor and electrically connected to the thin film transistor. The storage line is formed on the first substrate and positioned at a first boundary of each of the pixel areas while being spaced apart from the gate line. The floating electrodes are formed on the first substrate and positioned at a second boundary of each of the pixel areas while being spaced apart from the gate line and the storage line. The second substrate is coupled with the first substrate.

According to the above, the array substrate and the display apparatus may prevent the misalignment between a light blocking member and the pixel areas and enhance an aperture ratio of the pixel areas, thereby realizing a high quality image.

### BRIEF DESCRIPTION OF THE DRAWINGS

Exemplary embodiments of the present invention can be understood in more detail from the following descriptions taken in conjunction with the accompanying drawings, in which:

FIG. 1 is a plan view showing a liquid crystal display apparatus according to an exemplary embodiment of the present invention;

FIG. 2 is an equivalent circuit diagram showing pixels of FIG. 1;

FIG. 3 is a plan view showing a light blocking member of FIG. 1;

FIG. 4A is a cross-sectional view taken along a line I-I′ of FIG. 1;

FIG. 4B is a cross-sectional view taken along a line II-II′ of FIG. 1;

FIG. 5 is a plan view showing a liquid crystal display apparatus according to an exemplary embodiment of the present invention;

FIG. 6 is an equivalent circuit diagram showing pixels of FIG. 5;

FIG. 7 is a plan view showing a light blocking member of FIG. 5;

FIG. 8 is a cross-sectional view taken along a line III-III′ of FIG. 5;

FIG. 9 is a plan view showing a liquid crystal display apparatus according to an exemplary embodiment of the present invention;

FIG. 10 is an enlarged view of a portion ‘A’ of FIG. 9; and

FIG. 11 is a cross-sectional view taken along a line IV-IV′ of FIG. 9.

### DESCRIPTION OF EXEMPLARY EMBODIMENTS

The invention is described more fully hereinafter with reference to the accompanying drawings, in which embodiments of the invention are shown. It will be understood that when an element such as a layer, film, area, or substrate is referred to as being “on” another element, it can be directly on the other element or intervening elements may also be present.

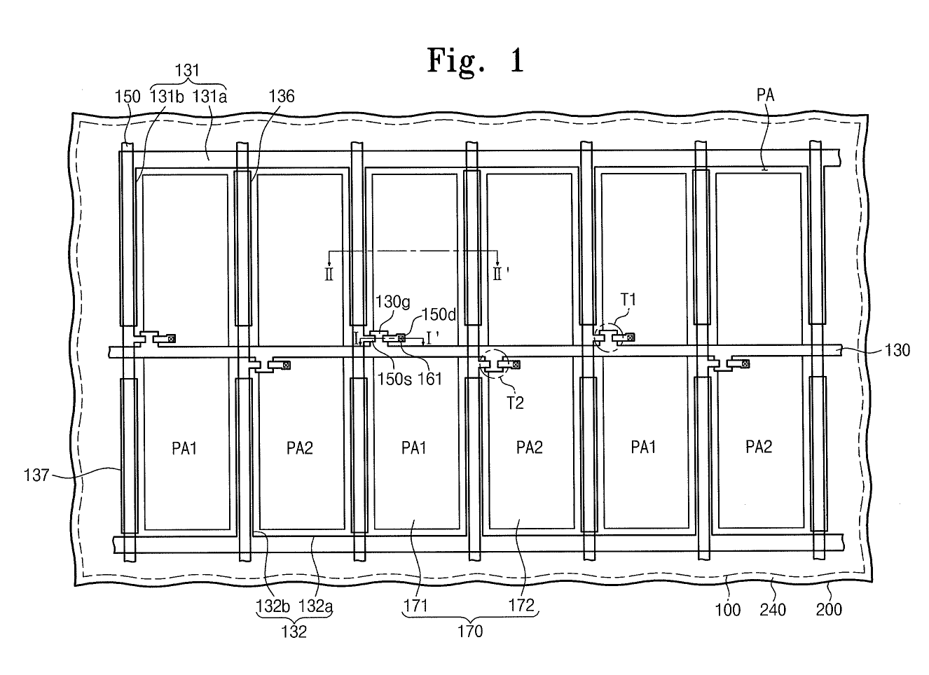

FIG. 1 is a plan view showing a liquid crystal display apparatus according to an exemplary embodiment of the present invention.

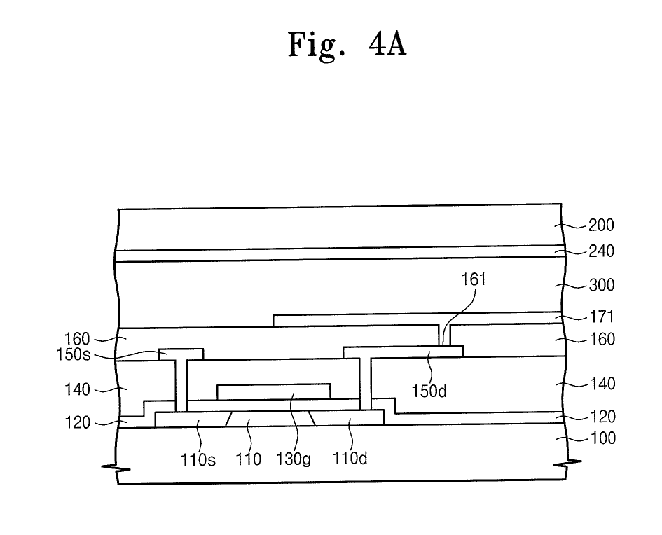

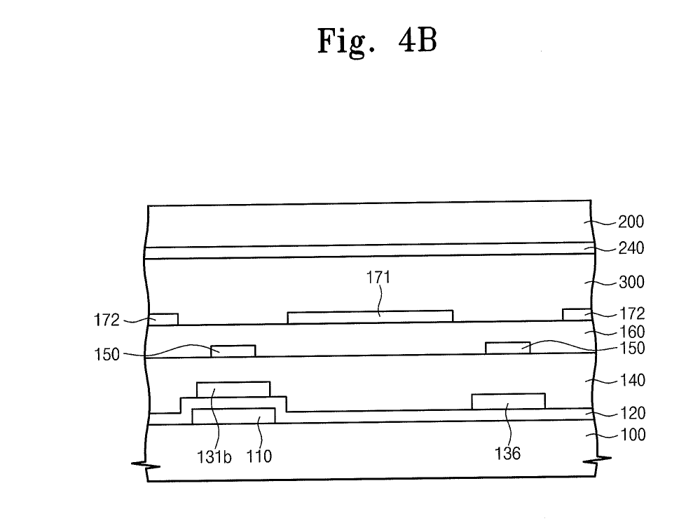

Referring to FIG. 1, a liquid crystal display apparatus includes a first substrate 100 on which a plurality of pixel areas PA are formed, a second substrate 200 opposite to the first substrate 100 and a liquid crystal layer (shown in FIG. 4A) disposed between the first and second substrates 100 and 200. The first and second substrates 100 and 200 may face each other. The first substrate 100 includes a plurality of pixel electrodes 170 spaced apart from each other by a predetermined distance, and the second substrate 200 includes a common electrode 240 formed thereon. Each of the pixel electrodes 170 is divided into a first pixel electrode 171 and a second pixel electrode 172 in accordance with a polarity of a voltage applied to the first and second pixel electrodes 171 and 172. Each of the pixel areas PA is divided into a first pixel area PA1 in which the first pixel electrode 171 is formed and a second pixel area PA2 in which the second pixel electrode 172 is formed.

The first substrate 100 includes various conductive patterns such as, for example, a gate line 130, storage lines 131 and 132, floating electrodes 136 and 137, and a data line 150.

The gate line 130 extends in a row direction to divide the pixel area PA into two parts. The storage lines 131 and 132 include a first storage line 131 and a second storage line 132 with the gate line 130 therebetween. The first storage line 131 includes a main line 131a and a sub line 131b. The second storage line 132 includes a main line 132a and a sub line 132b. The main lines 131a and 132a extend substantially parallel to the gate line 130, and the sub lines 131b and 132b are branched from the main lines 131a and 132a, respectively, and extend perpendicular to the main lines 131a and 132a.

The first floating electrode 136 is formed in an area in which the first storage line 131 is formed, and the second floating electrode 137 is formed in an area in which the second storage line 132 is formed with respect to the gate line 130. The first and second floating electrodes 136 and 137 are substantially parallel to the sub lines 131b and 132b.

The sub line 131b of the first storage line 131 and the first floating electrode 136 are alternately formed along the gate line 130. The sub line 132b of the second storage line 132 and the second floating electrode 137 are also alternately formed along the gate line 130. The sub line 131b of the first storage line 131 and the second floating electrode 137 are symmetrically positioned with respect to the gate line 130. The sub line 132b of the second storage line 132 and the first floating electrode 136 are symmetrically positioned with respect to the gate line 130.

The data line 150 extends in a direction substantially perpendicular to the gate line 130. The data line 150 is partially overlapped with the sub lines 131b and 132b, the first floating electrode 136 and the second floating electrode 137.

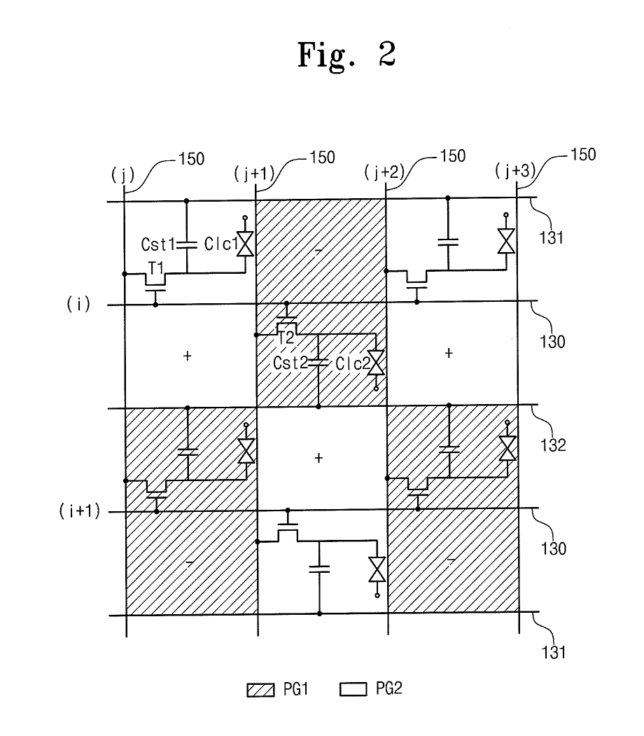

FIG. 2 is an equivalent circuit diagram showing pixels of FIG. 1.

Referring to FIG. 2, plural gate lines 130 extending in the row direction, the first and second storage lines 131 and 132 and plural data lines 150 extending in the column direction.

The pixels are divided into a first group PG1 formed in the first pixel area PA1 and a second group PG2 formed in the second pixel area PA2. The pixel of the first group PG1 and the pixel of the second group PG2 are alternately arranged along the row and column directions. In other words, odd-numbered pixels included in an i-th row belong to the first group PG1 and even-numbered pixels included in the i-th row belong to the second group PG2. On the contrary, even-numbered pixels included in an (i+1)th row belong to the first group PG1 and odd-numbered pixels included in the (i+1)th row belong to the second group PG2.

Each of the pixels in the first group PG1 includes a first thin film transistor T1, a first liquid crystal capacitor Clc1 and a first storage capacitor Cst1. The first thin film transistor T1 includes a gate electrode 130g connected to a corresponding gate line among the gate lines 130, a source electrode 150s connected to a corresponding data line among the data lines 150, and a drain electrode 150d connected to a first liquid crystal capacitor Clc1.

The first liquid crystal capacitor Clc1 includes the first pixel electrode 171 connected to the drain electrode 150d, the common electrode 240, and the liquid crystal layer disposed between the first pixel electrode 171 and the common electrode 240.

The first storage capacitor Cst1 is connected to the first liquid crystal capacitor Clc1. The first storage capacitor Cst1 is formed by an active layer 110 (shown in FIG. 4B) formed on the first substrate 100, the first storage line 131 and an insulation layer 120 (shown in FIG. 4B) disposed between the active layer 110 and the first storage line 131.

Each of the pixels in the second group PG2 includes a second thin film transistor T2, a second liquid crystal capacitor Clc2 and a second storage capacitor Cst2. The second thin film transistor T2 includes a gate electrode 130g connected to the gate lines 130, a source electrode 150s connected to the data lines 150, and a drain electrode 150d connected to a second liquid crystal capacitor Clc1.

The second liquid crystal capacitor Clc2 includes the second pixel electrode 172 connected to the drain electrode 150d, the common electrode 240, and the liquid crystal layer disposed between the second pixel electrode 172 and the common electrode 240.

The second storage capacitor Cst2 is connected to the second liquid crystal capacitor Clc2. The second storage capacitor Cst2 is formed by an active layer formed on the first substrate 100, the second storage line 132, and an insulation layer disposed between the active layer and the first storage line 132.

When the first and second transistors T1 and T2 are turned on in response to the gate voltage applied from the gate line 130, the data voltage is applied to the pixel electrodes 170 and the common voltage is applied to the common electrode 240, so that an electric field is formed between the pixel electrodes 170 and the common electrode 240 due to an electric potential difference between the data voltage and the common voltage. Liquid crystal molecules of the liquid crystal layer are aligned in various directions in accordance with the electric field. The liquid crystal molecules have an anisotropic refractive index and have various light transmittances according to the alignment directions thereof. Thus, the liquid crystal display apparatus controls the alignment directions of the liquid crystal molecules using the electric field to display an image corresponding to the light transmittances.

During operation of the liquid crystal display, the polarity of the data voltage applied to the pixel electrodes 170 is inverted at every frame with reference to the common voltage. When the liquid crystal molecules are aligned in one specific direction, the liquid crystal molecules can be deteriorated. The inversion of the polarity of the data voltage at every frame is referred to as an inversion driving method.

As the inversion driving method, a frame inversion method, a line inversion method and a dot inversion method may be employed. The frame inversion method inverts the polarity of the data voltage at every frame with respect to the common voltage of a direct current type, the line inversion method inverts the polarity of the data voltage at every line or at least two lines with respect to the common voltage of an alternating current type, and the dot inversion method inverts the polarity of the data voltage at every pixel.

In an exemplary embodiment, when the liquid crystal display apparatus employs the dot inversion method, the pixels in the first group PG1 receive the data voltage having a different polarity from that of the data voltage applied to the pixels in the second group PG2. More specifically, when the data voltage having a positive polarity (+) is applied to the pixels in the first group PG1 during a predetermined frame, the data voltage having a negative polarity (−) is applied to the pixels in the second group PG2 during the predetermined frame. On the contrary, when the data voltage having the negative polarity (−) is applied to the pixels in the first group PG1 during a next frame, the data voltage having the positive polarity (+) is applied to the pixels in the second group PG2. The dot inversion method can be suitable to prevent a flicker phenomenon of which a screen flickers whenever the frames are changed.

During operation of the liquid crystal display, the alternating current voltage corresponding to each first and second storage capacitors Cst1 and Cst2 is applied to the first and second storage lines 131 and 132. The charged voltage in the first liquid crystal capacitor Clc1 is boosted up by the first storage capacitor Cst1 when the alternating current voltage is changed from a low level to a high level. Thus, the first storage capacitor Cst1 may increase a charge-maintaining time of the first liquid crystal capacitor Clc2. The charged voltage in the second liquid crystal capacitor Clc2 is boosted up by the second storage capacitor Cst2 when the alternating current voltage is changed from the low level to the high level. Accordingly, the second storage capacitor Cst2 may enhance the charge-maintaining time of the second liquid crystal capacitor Clc2.

The liquid crystal molecules may be abnormally aligned between the pixels when the liquid crystal display is operated. Thus, the light blocking member is formed between the pixels such that the light does not pass through the liquid crystal molecules that are abnormally aligned. The aperture ratio of each pixel depends on the size of the light blocking member formed between the pixels.

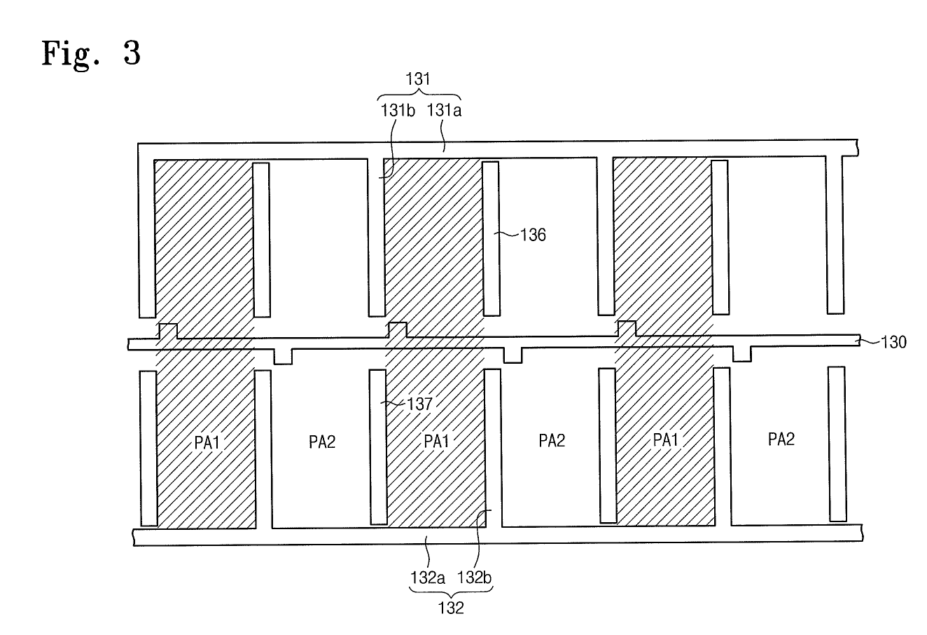

FIG. 3 is a plan view showing a light blocking member of FIG. 1.

Referring to FIG. 3, the first and second storage lines 131 and 132, and the first and second floating electrodes 136 and 137 act as the light blocking member. In the first pixel area PA1 having a rectangle, the main line 131a of the first storage line 131 is positioned at an upper border of the first pixel area PA1 with reference to the gate line 130, which is corresponding to the row direction of the gate line 130. The sub line 131b of the first storage line 131 and the first floating electrode 136 are positioned at both upper-side borders of the first pixel area PA1, which is corresponding to the column direction perpendicular to the row direction of the gate line 130. The main line 132a of the second storage line 132 is positioned at a lower border of the first pixel area PA1 with reference to the gate line 130, which is corresponding to the row direction of the gate line 130. The sub line 132b of the second storage line 132 and the second floating electrode 137 are positioned at both lower-side borders of the first pixel area PA1, which is corresponding to the column direction perpendicular to the row direction of the gate line 130.

In the second pixel area PA2, the main lines 131a and 132a of the first and second storage lines 131 and 132 are positioned at upper and lower borders of the second pixel area PA2 with reference to the gate line 130, respectively, which are corresponding to the row direction of the gate line 130. The sub line 131b and the first floating electrode 136 are positioned at upper-side borders of the second pixel area PA2, and the sub line 132b and the second floating electrode 137 are positioned at lower-side borders of the second pixel area PA2. In an exemplary embodiment, the sub line 131b of the first storage line 131, the sub line 132b of the second storage line 132, the first floating electrode 136, and the second floating electrode 137 in the second pixel area PA2 are positioned opposite to those in the first pixel area PA1.

The first and second storage lines 131 and 132, and the first and second floating electrodes 136 and 137 include a conductive material having an opaque property. The conductive material may include metal, such as, for example, chromium, copper, aluminum, molybdenum, or an alloy thereof. Since the first and second storage lines 131 and 132 and the first and second floating electrodes 136 and 137 have the opaque property, the first and second storage lines 131 and 132 and the first and second floating electrodes 136 and 137 may be used as the light blocking member.

The first and second storage lines 131 and 132, and the first and second floating electrodes 136 and 137 are formed on the first substrate 100 on which the pixel areas PA are formed. When the light blocking member is positioned between the pixel areas PA, the misalignment may be prevented in comparison with forming the light blocking member on the second substrate 200. Since the misalignment may be prevented, a size of the light blocking member may be reduced, thereby enhancing the aperture ratio of the liquid crystal display.

FIG. 4A is a cross-sectional view taken along a line I-I′ of FIG. 1, and FIG. 4B is a cross-sectional view taken along a line II-II′ of FIG. 1.

Referring to FIG. 4A, the liquid crystal display apparatus includes the first substrate 100, the second substrate 200 and the liquid crystal layer 300 disposed between the first and second substrates 100 and 200.

In an exemplary embodiment, the active layer 110 is formed on the first substrate 100. The active layer 110 is formed by patterning a polysilicon layer. The polysilicon layer may be directly deposited onto the first substrate 100 or may be formed by crystallizing amorphous silicon after depositing the amorphous silicon onto the first substrate 100. The active layer 110 includes a source region 110s and a drain region 110d into which impurities are implanted.

The active layer 110 is covered by the gate insulation layer 120. The gate insulation layer 120 may be formed over the first substrate 100 using a plasma enhanced chemical vapor deposition method. The gate electrode 130g is formed on the gate insulation layer 120 and is corresponding to between the source and drain regions 110s and 110d. The gate electrode 130g is covered by a first insulating interlayer 140 formed over the first substrate 100. The source electrode 150s connected to the source region 110s and the drain electrode 150d connected to the drain region 110d are formed on the first insulating interlayer 140. The first thin film transistor T1 (or the second thin film transistor T2) includes the source electrode 150s, the drain electrode 150d and the gate electrode 130g.

As the above-described, the first thin film transistor T1 has a top-gate structure in which the gate electrode 130g is located over the active layer 110. However, the first thin film transistor T1 is not limited to the top-gate structure and may be applied to a bottom-gate structure in which the gate electrode 130g is positioned under the active layer 110.

The first thin film transistor T1 is covered by a second insulating interlayer 160. The first pixel electrode 171 (or the second pixel electrode) is formed on the second insulating interlayer 160. The first pixel electrode 171 is formed by patterning a transparent conductive layer, such as, for example indium tin oxide, or indium zinc oxide. The first pixel electrode 171 is electrically connected to the drain electrode 150d of the first thin film transistor T1 through a contact hole 161.

Referring to FIG. 4B, the first storage capacitor Cst1 (or the second storage capacitor Cst2) is formed on the first substrate 100 corresponding to between the pixel areas PA. The first storage capacitor Cst1 is formed by the active layer 110, the first storage line 131 and the gate insulation layer 120. The first floating electrode 136 (or the second floating electrode 137) is formed on the gate insulation layer 120, which is spaced apart from the sub line 131b of the first storage lien 131. The gate insulation layer 120 is disposed between the first floating electrode 136 and the first substrate 100. The first insulating interlayer 140, the data line 150 and the second insulating interlayer 160 are sequentially formed on the first substrate 100 on which the first storage capacitor Cst1 and the first floating electrode 136 are formed. The first and second pixel electrodes 171 and 172 are alternately formed on the second insulating interlayer 160 according to the pixel areas PA.

Since the first and second pixel electrodes 171 and 172 receive the data voltage having different polarities from each other in accordance with the dot inversion method, the electric field is formed between the first and second pixel electrodes 171 and 172. The electric field distorts the alignment of the liquid crystal molecules of the liquid crystal layer 300, thereby deteriorating display quality in the region between the first and second pixel electrodes 171 and 172. Therefore, in order to block the light passing through the region between the first and second pixel electrodes 171 and 172 of the liquid crystal display employing the dot inversion driving method, the first and second storage lines 131 and 132 and the first and second floating electrodes 136 and 137 used as the light blocking member need to have a size enough to block the light. In an exemplary embodiment, the light blocking member of the liquid crystal display adopting the line inversion driving method may have a width in a range of about 7 micrometers to about 8 micrometers, preferably about 7.5 micrometers. In an exemplary embodiment, the light blocking member in the liquid crystal display to which the dot inversion driving method is applied has a width in a range of about 9 micrometers to about 10 micrometers, preferably about 9.5 micrometers.

Thus, the sub lines 131b and 132b, and the first and second floating electrodes 136 and 137 used as the light blocking member of the liquid crystal display to which the dot inversion driving method is applied have a width of about 9.5 micrometers. The width of the light blocking member under the dot inversion driving method is greater than the width of the light blocking member under the line inversion driving method by about 2 micrometers, so that the aperture ratio of the pixel areas PA may be reduced by about 2 micrometers.

Capacitances of the first and second storage capacitors Cst1 and Cst2 may increase in accordance with increase of the width of the sub lines 131b and 132b. Thus, the charge time of the first and second liquid crystal capacitors Clc1 and Clc2 may be enhanced.

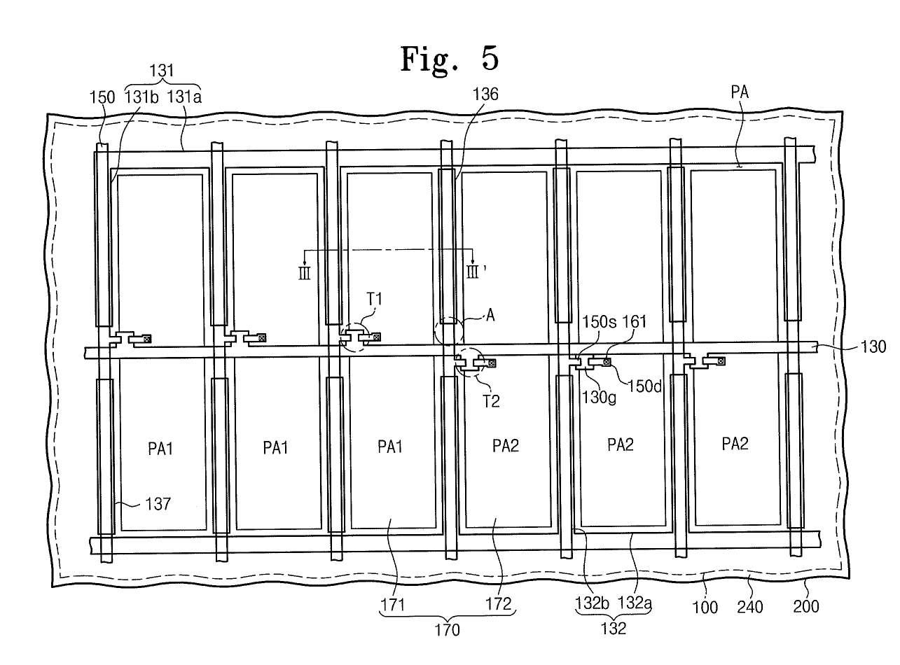

FIG. 5 is a plan view showing a liquid crystal display apparatus according to an exemplary embodiment of the present invention. In FIG. 5, the same reference numerals denote the same elements in FIG. 1, and thus the detailed descriptions of the same elements will be omitted.

Referring to FIG. 5, the liquid crystal display apparatus includes a first substrate 100 and a second substrate 200 facing the first substrate 100. The first substrate 100 includes a plurality of pixel areas PA. The pixel electrodes 170 are formed in the pixel areas PA. Each of the pixel electrodes 170 is divided into a first pixel electrode 171 and a second pixel electrode 172 in accordance with a polarity of a voltage applied thereto. Each of the pixel areas PA is divided into a first pixel area PA1 in which the first pixel electrode 171 is formed and a second pixel area PA2 in which the second pixel electrode 172 is formed. Three first pixel areas PA1 and three second pixel areas PA2 are alternately arranged.

The first substrate 100 includes a gate line 130, storage lines 131 and 132, and floating electrodes 136 and 137. The gate line 130 crosses the pixel areas PA. The storage lines 131 and 132 include a first storage line 131 and a second storage line 132. The first storage line 131 includes a main line 131a and a sub line 131b, and the second storage line 132 includes a main line 132a and a sub line 132b. The floating electrodes 136 and 137 are substantially parallel to the sub lines 131b and 132b. Similar to the first and second pixel areas PA1 and PA2, three sub lines 131b of the first storage line 131 and three first floating electrodes 136 are alternately arranged, and three sub lines 132b of the second storage line 132 and three second floating electrodes 137 are also alternately arranged. The sub line 131b of the first storage line 131 and the second floating electrode 137 are positioned symmetrical with respect to the gate line 130, and also the sub line 132b of the second storage line 132 and the first floating electrode 136 are positioned symmetrical with respect to the gate line 130.

The data line 150 extends in a vertical direction with respect to the gate line 130. The data line 150 is partially overlapped with the sub lines 131b and 132b, and the first and second floating electrodes 136 and 137.

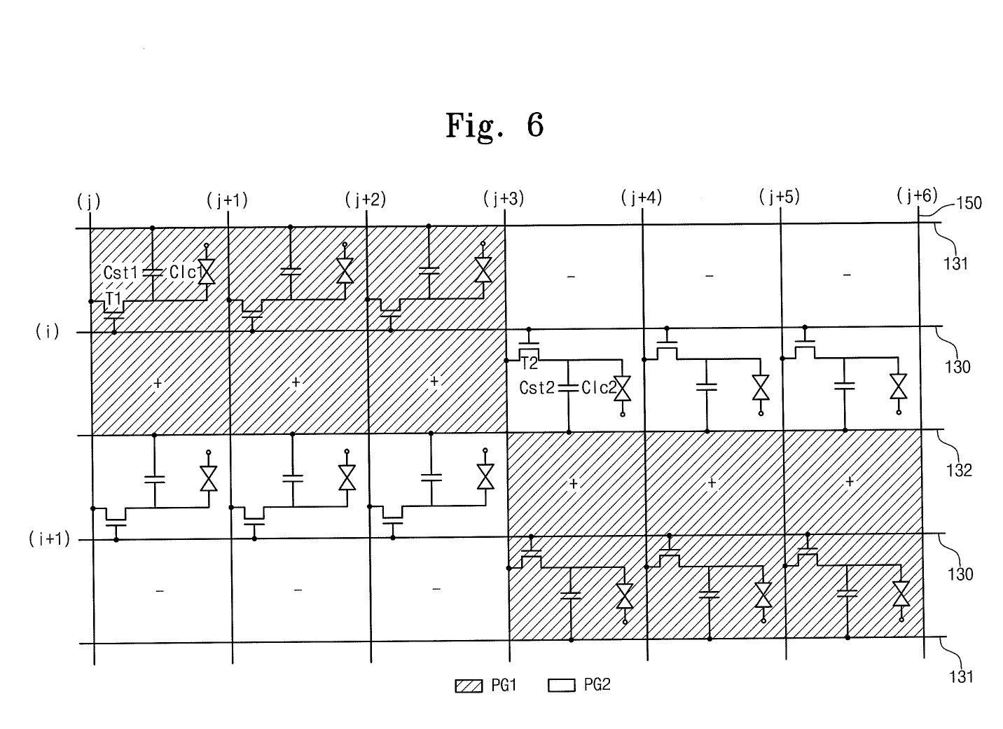

FIG. 6 is an equivalent circuit diagram of pixels of FIG. 5.

Referring to FIG. 6, the pixels are divided into a first group PG1 formed in the first pixel area PA1 and a second group PG2 formed in the second pixel area PA2. Three pixels in the first group PG1 and three pixels in the second group PG2 are alternately arranged.

Each of the pixels in the first group PG1 includes a thin film transistor T1, a first liquid crystal capacitor Clc1 and a first storage capacitor Cst1. Each of the pixels in the second group PG2 includes a second thin film transistor T2, a second liquid crystal capacitor Clc2 and a second storage capacitor Cst2.

When the liquid crystal display is operated, the pixels in the first group PG1 receive a data voltage having different polarity from that of the data voltage applied to the pixels in the second group PG2. In other words, a dot inversion driving method of which the polarity of the data voltage applied to the pixel electrodes 170 is inverted at every three pixels along the row direction is applied to the liquid crystal display, so that the flicker phenomenon may be prevented. The liquid crystal display may include a light blocking member to block the light passing through the liquid crystal molecules that are abnormally aligned between the pixel areas PA.

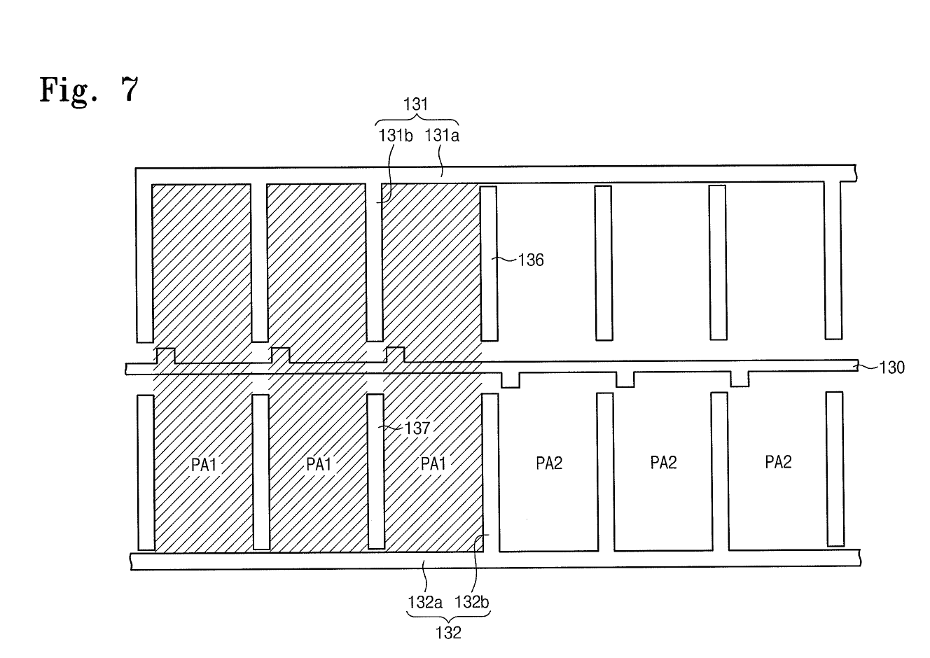

FIG. 7 is a plan view showing a light blocking member of FIG. 5.

Referring to FIG. 7, the first storage line 131, the second storage line 132, the first floating electrode 136 and the second floating electrode 137 act as the light blocking member. The main lines 131a and 132b are positioned at upper and lower borders of the first pixel areas PA1, respectively. In three successive first pixel areas PA1, two pixel areas of the first pixel areas PA1 have a bilateral symmetry and one pixel area of the first pixel areas PA1 has a bilateral asymmetry. The sub line 131b of the first storage line 131 is positioned at both upper-side borders of the two pixel areas PA1 with respect to the gate line 130 and the second floating electrode 137 is positioned at both lower-side borders of the two pixel areas of the first pixel areas PA1 with respect to the gate line 130. The sub line 131b of the first storage line 131 is positioned at a left upper-side border of the one pixel area of the first pixel areas PA1 having a bilateral symmetry and the second floating electrode 137 is positioned at a left lower-side border of the one pixel area of the first pixel areas PA1 having a bilateral symmetry. The first floating electrode 136 is positioned at a right upper-side border of the one pixel area of the first pixel areas PA1 having a bilateral symmetry and the sub line 132b of the second storage line 132 is positioned at a right lower-side border of the one pixel area of the first pixel areas PA1 having a bilateral symmetry.

In three successive second pixel areas PA2, the main lines 131a and 132b are positioned at upper and lower borders of the second pixel areas PA2, respectively. In three successive second pixel areas PA2, two pixel areas of the second pixel areas PA2 have a bilateral symmetry and one pixel area of the second pixel areas PA2 has a bilateral asymmetry. In other words, the floating electrode 136 is positioned at both upper-side borders of the two pixel areas of the second pixel areas PA2 having a bilateral symmetry with respect to the gate line 130, and the sub line 132b of the second storage line 132 is positioned at both lower-side borders of the two pixel areas of the second pixel areas PA2. The first floating electrode 136 is positioned at a left upper-side border of the one pixel area of the second pixel areas PA2 having a bilateral symmetry, and the sub line 132b of the second storage line 132 is positioned at a left lower-side border of the one pixel area of the second pixel areas PA2 having a bilateral symmetry. The sub line 131b of the first storage line 131 is positioned at a right upper-side border of the one pixel area of the second pixel areas PA2 having a bilateral symmetry, and the second floating electrode 137 is positioned at a right lower-side border of the one pixel area of the second pixel areas PA2 having a bilateral symmetry.

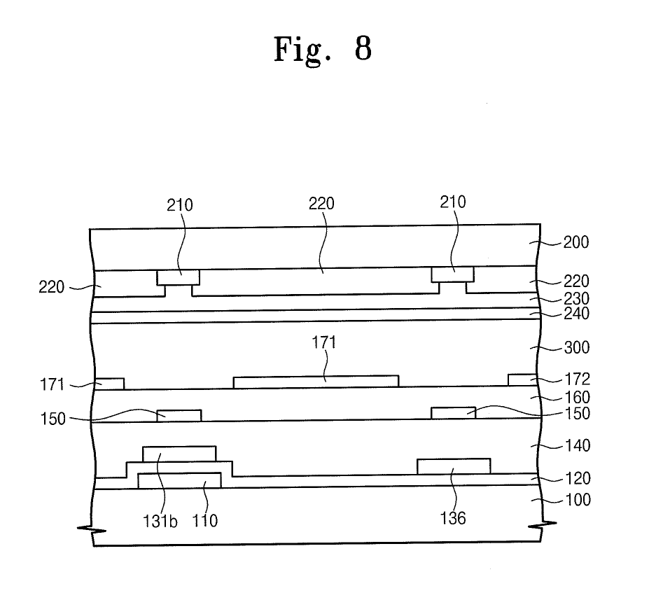

FIG. 8 is a cross-sectional view taken along a line III-III′ of FIG. 5.

Referring to FIG. 8, an active layer 110, a gate insulation layer 120, the sub line 131b of the first storage line 131, the first floating electrode 136, a first insulating interlayer 140, the data line 150, a second insulating interlayer 160, a first pixel electrode 171 and a second pixel electrode 172 are formed on the first substrate 100.

A black matrix 210, a color filter 220, a planarizing layer 230 and a common electrode 240 are formed on the second substrate 200. The black matrix 210 is formed corresponding to between the pixel areas PA. The black matrix 210 may include, for example, metal or an organic material to support the light blocking member formed on the first substrate 100. When the light blocking member is enough to block the light, the black matrix 210 may be removed from the second substrate 200.

The color filter 220 may include, for example, red, green and blue color filters that are alternately arranged along the pixel areas PA to display a color image. The black matrix 210 formed between the pixel areas PA prevents a mixture of the red, green and blue colors caused by the red, green and blue color filters.

The planarizing layer 230 planarizes a surface of the second substrate 200 to prevent a step-difference between the black matrix 210 and the color filter 220, and the common electrode 240 is formed on the planarizing layer 230.

In FIGS. 1 to 8, the light blocking member of the liquid crystal display to which 1×1 dot inversion or 3×1 dot inversion driving method is applied has been described as exemplary embodiments of the present invention. However, the light blocking member may be applied to a liquid crystal display to which more than 3×1 dot inversion driving method is applied.

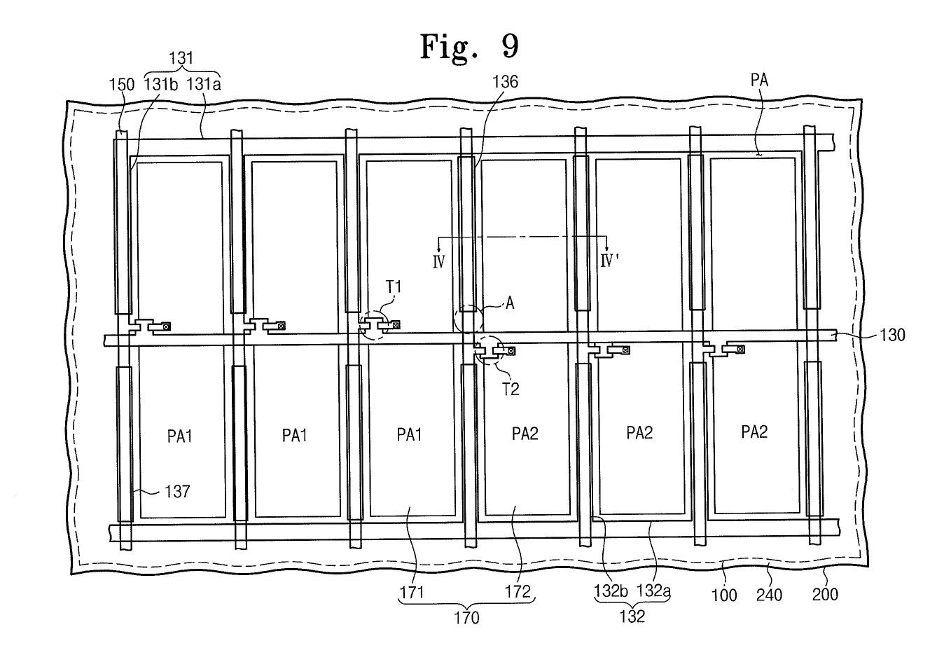

FIG. 9 is a plan view showing a liquid crystal display apparatus according to an exemplary embodiment of the present invention. In FIG. 9, the same reference numerals denote the same elements in FIGS. 1 and 5, and thus the detailed descriptions of the same elements will be omitted.

Referring to FIG. 9, the liquid crystal display apparatus includes the first substrate 100 and the second substrate 200 positioned opposite the first substrate 100. The first substrate 100 includes a plurality of areas PA. The pixel electrodes 170 are formed in the pixel areas PA. Each of the pixel electrodes 170 is divided into a first pixel electrode 171 and a second pixel electrode 172 in accordance with a polarity of a voltage applied thereto. Each of the pixel areas PA is divided into a first pixel area PA1 in which the first pixel electrode 171 is formed and a second pixel area PA2 in which the second pixel electrode 172 is formed. Three first pixel areas PA1 and three second pixel areas PA2 are alternately arranged, and the liquid crystal display employs the 3×1 dot inversion driving method.

The first substrate 100 includes a gate line 130, first and second storage lines 131 and 132, first and second floating electrodes 136 and 137 and a data line 150.

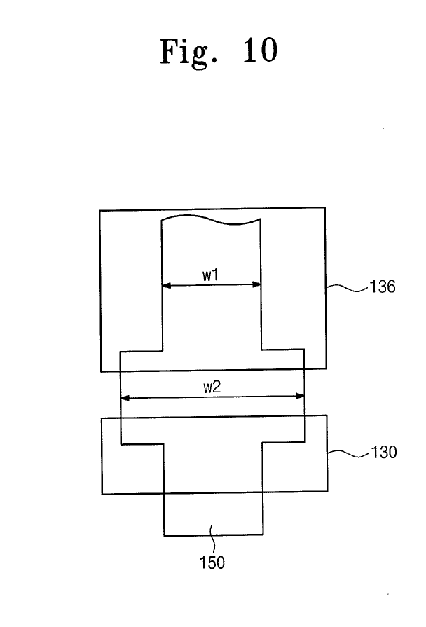

FIG. 10 is an enlarged view of a portion ‘A’ of FIG. 9.

Referring to FIG. 10, the data line 150 may have an uneven width. The data line 150 has a first width W1 and extends in a vertical direction to the gate line 130. The first width W1 of the data line 150 expands to a second width W2 in a region where the gate line 130 and the first floating electrode 136 are adjacent to each other. The first width W1 is narrower than a width of the first floating electrode 136, and the second width W2 substantially corresponds to the width of the first floating electrode 136.

The gate line 130 and the first floating electrode 136 are spaced apart from each other in the region in which the data line 150 has the second width W2 such that the gate line 130 and the first floating electrode 136 are not electrically shorted to each other. Since the data line 150 has the second width W2 wider than the first width W1 in the region where the gate line 130 and the first floating electrode 136 are spaced apart from each other, the data line 150 may prevent leakage of light passing through the region between the gate line 130 and the first floating electrode 136.

The width of the data line 150 may be expanded to block the light passing through the regions between the gate line 130 and the second floating electrode 137, between the gate line 130 and the sub lines 131b and 132b, between the main line 131a of the first storage line and the first floating electrode 136, and between the main line 132a of the second storage line and the second floating electrode 137.

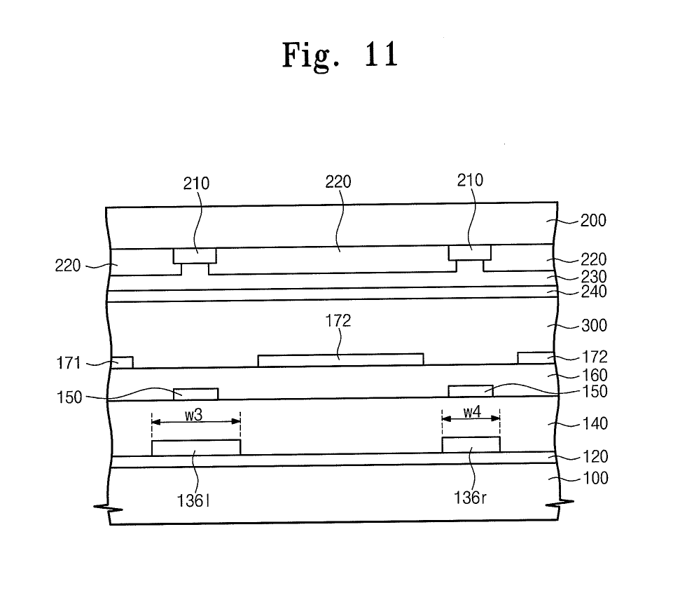

Although the width of the data line 150 is not expanded, the black matrix 210 (shown in FIG. 11) formed on the second substrate 200 corresponding to between the pixel areas PA may prevent the light leakage.

FIG. 11 is a cross-sectional view taken along a line IV-IV′ of FIG. 9.

Referring to FIG. 11, a gate insulation layer 120 is formed on the first substrate 100, and the first floating electrode 136 is formed on the gate insulation layer 120. The first floating electrode 136 is spaced apart from a first floating electrode adjacent thereto with the pixel area PA therebetween. The first insulating interlayer 140, the data line 150, the second insulating interlayer 160, the first pixel electrode 171 and the second pixel electrode 172 are sequentially formed on the first substrate 100 on which the first floating electrode 136 is formed.

The second substrate 200 includes the black matrix 210, the color filter 220, the planarizing layer 230, and the common electrode 240. The liquid crystal layer 300 is disposed between the first and second substrates 100 and 200.

The first floating electrode 136 has an uneven width in accordance with its positions on the gate insulation layer 120. As shown in FIG. 11, when the first floating electrode 136 is divided into a left-first floating electrode 1361 and a right-first floating electrode 136r, the left-first floating electrode 1361 has a third width W3 and the right-first floating electrode 136r has a fourth width W4 narrower than the third width W3.

Referring to FIG. 9, the left-first floating electrode 136l is positioned between the first pixel area PA1 and the second pixel area PA2, and the right-first floating electrode 136r is positioned between the second pixel areas PA2.

With the dot inversion driving method, a strong electric field is formed between the first and second pixel areas PA1 and PA2, compared to the electric field formed between the first pixel areas PA1 or between the second pixel areas PA2, because the first and second pixel electrodes 171 and 172 receive the data voltages having the different polarities, respectively. Due to the electric field, most of the liquid crystal molecules may be abnormally aligned between the first and second pixel areas PA1 and PA2, so that the left-first floating electrode 136 has a width enough to block the light passing through the abnormally-aligned liquid crystal molecules. However, an electric field weaker than the strong electric field is formed between the second pixel areas PA2 (or between the first pixel areas PA1) since the second pixel electrodes 172 receive the data voltages having the same polarity. Accordingly, the abnormally-aligned liquid crystal molecules are not so much between the second pixel areas PA2 (or between the first pixel areas PA1), so that it is enough that the right-first floating electrode 136r has the fourth width W4 narrower than the third width W3. In an exemplary embodiment, the third width W3 is in a range of about 9 micrometers to about 10 micrometers, and preferably about 9.5 micrometer. The fourth width W4 is in a range of about 7 micrometers to about 8 micrometers, and preferably about 7.5 micrometers.

Although not shown in FIG. 11, when the second floating electrode 137, the sub line 131b of the first storage line and the sub line 132b of the second storage line are positioned between the first and second pixel areas PA1 and PA2, each of them have the third width W3. When the second floating electrode 137, the sub line 131b of the first storage line and the sub line 132b of the second storage line are positioned between the first pixel areas PA1 or between the second pixel areas PA2, each of them have the fourth width W4.

As the above-described, since the width of the light blocking member positioned between the first pixel areas PA1 or between the second pixel areas PA2 is reduced, the aperture ratio of the liquid crystal display may be enhanced by the reduced width of the light blocking member.

According to the above, the array substrate and the display apparatus may prevent the misalignment between the light blocking member and the pixel areas and enhance the aperture ratio of the pixel areas, thereby realizing a high quality image.

Although the exemplary embodiments of the present invention have been described herein with reference with the accompanying drawings, it is understood that the present invention is not be limited to these exemplary embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An array substrate comprising:
a gate line formed on a substrate;
a plurality of data lines insulated from the gate line;
a thin film transistor formed in a pixel area including a first sub-area and a second sub-area;
a pixel electrode formed on the thin film transistor, the pixel electrode electrically connected to the thin film transistor;
a storage line formed on the substrate, the storage line spaced apart from the gate line and positioned at a first boundary of the pixel area; and
a floating electrode formed on the substrate, wherein the floating electrode is spaced apart from the gate line and the storage line, and positioned at a second boundary of the pixel area.

2. The array substrate of claim 1, wherein the storage line comprises first and second storage lines each having a main line substantially parallel to the gate line and a sub line branched from the main line and positioned at boundaries of the first and second sub-areas, the floating electrode comprises first and second floating electrodes positioned substantially parallel to the sub line and positioned at boundaries of the first and second sub-areas, the sub line of the first storage line and the second floating electrode are positioned symmetrical with respect to the gate line, and the sub line of the second storage line and the first floating electrode are positioned symmetrical with respect to the gate line.

3. A display apparatus comprising:
a first substrate including a gate line and a plurality of data lines insulated from the gate line;
a thin film transistor formed in a pixel area having a first sub-area and a second sub-area;
a pixel electrode formed on the thin film transistor, the pixel electrode connected to the thin film transistor;
a storage line spaced apart from the gate line, wherein the storage line is positioned at a first boundary of the pixel area;
a floating electrode spaced apart from the gate line and the storage line, the floating electrode positioned at a second boundary of the pixel area; and
a second substrate coupled with the first substrate.

4. The display apparatus of claim 3, wherein the storage line comprises first and second storage lines having a main line substantially parallel to the gate line and a sub line branched from the main line and positioned at boundaries of the first and second sub-areas, the floating electrode comprises first and second floating electrodes positioned substantially parallel to the sub line and positioned at boundaries of the first and second sub-areas, the sub line of the first storage line is positioned in an area corresponding to the second floating electrode with respect to the gate line, and the sub line of the second storage line is positioned in an area corresponding to the first floating electrode with respect to the gate line.

5. The display apparatus of claim 4, wherein the first and second floating electrodes are perpendicular with respect to the gate line, the sub line of the first storage line and the second floating electrode are positioned symmetrical with respect to the gate line, and the sub line of the second storage line and the first floating electrode are positioned symmetrical with respect to the gate line.

6. The display apparatus of claim 5, wherein the pixel area comprises a first group and a second group, the first and second groups are alternately arranged along the gate line, and
the pixel electrode comprises:
a first pixel electrode formed in the pixel area of the first group; and
a second pixel electrode formed in the pixel area of the second group to which a data voltage having an opposite polarity to a data voltage applied to the first pixel electrode is applied.

7. The display apparatus of claim 6, wherein the data lines extend in a vertical direction with respect to the gate line along the first boundary or the second boundary of the pixel area and include a first data line corresponding to the pixel area of the first group and a second data line corresponding to the pixel area of the second group.

8. The display apparatus of claim 7, wherein the thin film transistor comprises:
a first thin film transistor comprising a first gate electrode branched from the gate line and positioned in the first sub-area, a first source electrode branched from the first data line and partially overlapped with the first gate electrode, and a first drain electrode spaced apart from the first source electrode and electrically connected to the first pixel electrode; and
a second thin film transistor comprising a second gate electrode branched from the gate line and positioned in the second sub-area, a second source electrode branched from the second data line and partially overlapped with the second gate electrode, and a second drain electrode spaced apart from the second source electrode and electrically connected to the second pixel electrode.

9. The display apparatus of claim 8, further comprising:
a first active layer disposed between the first substrate and the first gate electrode and between the first substrate and the first storage line; and
a second active layer disposed between the first substrate and the second gate electrode and between the first substrate and the second storage line.

10. The display apparatus of claim 9, wherein the first active layer comprises a first source area and a first drain area doped with an impurity and corresponding to the first source electrode and the first drain electrode, respectively, and the second active layer comprises a second source area and a first drain area doped with the impurity and corresponding to the second source electrode and the second drain electrode, respectively.

11. The display apparatus of claim 9, further comprising:
a first storage electrode formed by the first active layer and the first storage line overlapped with the first active layer; and
a second storage electrode formed by the second active layer and the second storage line overlapped with the second active layer.

12. The display apparatus of claim 6, wherein the pixel area of the first group and the pixel area of the second group are alternately formed by one pixel.

13. The display apparatus of claim 12, wherein the sub line comprises a same width as a width of the first and second floating electrodes.

14. The display apparatus of claim 13, wherein the width is in a range of about 9 micrometers to about 10 micrometers.

15. The display apparatus of claim 6, wherein the pixel area of the first group and the pixel area of the second group are alternately formed by at least two pixels.

16. The display apparatus of claim 15, wherein the sub line, the first floating electrode and the second floating electrode formed between the pixel area of the first group and the pixel area of the second group have a first width, and the sub line, the first floating electrode and the second floating electrode formed between the pixel area of the first group and between the pixel area of the second group have a second width smaller than the first width.

17. The display apparatus of claim 16, wherein the first width is in a range of about 9 micrometers to about 10 micrometers, and the second width is in a range of about 7 micrometers to about 8 micrometers.

18. The display apparatus of claim 4, wherein the first and second storage lines, the first and second floating electrodes, and the data lines comprise a conductive material to block light.

19. The display apparatus of claim 18, wherein the data lines comprise a first width to overlap the sub line, the first floating electrode and the second floating electrode, and have a second width greater than the first width in at least one area among a spaced area between the gate line and the sub line, a spaced area between the gate line and the first or second floating electrode, and a spaced area between the main line and the first or second floating electrode.

20. The display apparatus of claim 3, further comprising:
a color filter formed on the second substrate, the color filter corresponding to the pixel area; and
a common electrode formed on the color filter.
